(19) United States
(12) Patent Application Publication
(10) Pub. No.: US 2008/0140228 A1
(43) Pub. Date: Jun. 12, 2008

(54) MULTI-OBJECTIVE OPTIMIZATION METHOD FOR UBIQUITOUS COMPUTING ENVIRONMENT AND WEARABLE COMPUTER USING THE SAME

(76) Inventors: Dong-Oh KANG, Daejon (KR); Kyu-Chang KANG, Daejon (KR); Hyung-Jik LEE, Daejon (KR); Eun-Jung KO, Jeollabuk-do (KR); Jeun-Woo LEE, Daejon (KR)

Correspondence Address: LADAS & PARRY LLP, 224 SOUTH MICHIGAN AVENUE, SUITE 1600, CHICAGO, IL, 60604, US

(21) Appl. No.: 11/952,430

(22) Filed: Dec. 7, 2007

(30) Foreign Application Priority Data
Dec. 8, 2006 (KR) 10-2006-0124917

(51) Int. Cl. G05B 13/02

(52) U.S. Cl. 700/32

(57) ABSTRACT

Provided is a multi-objective optimization method in a ubiquitous computing environment. The wearable computer includes: a wireless communication unit configured to receive features of condition information and features of service from the outside; a feature collecting unit configured to collect features of condition information according to user's input, and the features of the condition information and the features of the service transmitted from the wireless communication unit; and a computing unit configured to perform the multi-objective optimization by using the features collected through the feature collecting unit in order for optimized user service.

### CROSS-REFERENCE(S) TO RELATED APPLICATIONS

The present invention claims priority of Korean Patent Application No. 10-2006-0124917 filed on Dec. 8, 2006, which is incorporated herein by reference.

### BACKGROUND OF THE INVENTION

1. Field of the Invention

The present invention relates to a multi-objective optimization method in a ubiquitous computing environment, a wearable computer using the same, a computer-readable recording medium storing a program for executing the multi-objective optimization method; and, more particularly, to a multi-objective optimization method in a ubiquitous computing environment, a wearable computer using the same, a computer-readable recording medium storing a program for executing the multi-objective optimization method, in which a user service can be provided using the multi-objective optimization in the ubiquitous computing environment in consideration of user's requirements, e.g., response speed of the user service, and limitations based on a variety of condition information, thereby increasing the user's service satisfaction.

This work was supported by the IT R&D program for MIC/IITA [2005-S-069-02, “Development of Wearable System Using Physiological Signal Processing”].

2. Description of Related Art

A wearable computer refers to a computer that is wearable like clothing, a computer that is wearable like a wristwatch, and a wireless communication terminal that is portable like a mobile terminal or a personal digital assistant (PDA).

In recent years, as communication environments have been developed and wireless communication terminals have been popularized, there is an increasing interest in ubiquitous environment where users can receive a variety of services anywhere anytime. A wearable computer has been introduced which allows users to receive services more conveniently. The wearable computer has an advantage in that it can receive the support of a computer while performing other operations, without stopping or shifting a current running operation.

The wearable computer is widely used in a data processor, an output device, and an input device. The output device includes a display device, e.g., a head mounted display (HMD), and the input device includes a virtual keyboard, a voice input device, and a chord keyboard that allows users to enter a test by pressing several keys together.

Such a wearable computer communicates with one or more wearable sensors through a communication module. The wearable sensors acquire user's biological signals and transmit them to the wearable computer. The wearable computer provides a variety of services to the user, considering internal condition information including the biological signals and user's input such as user's requirements of the services, and external condition information acquired from the outside. The wearable computer and the wearable sensor construct a wearable system.

The user wearing the wearable computer can receive a plurality of user services in the ubiquitous computing environment.

Generally, quality and performance of the user service are determined depending on types of services from the service provider and methods of acquiring internal/external condition information. For example, the quality and performance of the user service and the user's satisfaction are changed depending on memory status and battery status of the wearable system, accuracies of a variety of condition information, and response speed of the user service.

The wearable system provides a variety of user services in the ubiquitous computing environment, while not sufficiently considering the user's requirements and limitations based on a variety of condition information. Hence, the wearable system has not provided satisfactory user services to the users. That is, the conventional technologies to provide the user services to the users fail to provide services that are optimized according to user's priorities.

### SUMMARY OF THE INVENTION

An embodiment of the present invention is directed to providing a multi-objective optimization method in a ubiquitous computing environment, a wearable computer using the same, a computer-readable recording medium storing a program for executing the multi-objective optimization method, in which a user service is provided after the multi-objective optimization, e.g., a min-max multi-objective optimization, in the ubiquitous computing environment in consideration of user's requirements, e.g., response speed of the user service, and limitations based on a variety of condition information, thereby increasing the user's service satisfaction.

Another embodiment of the present invention is directed to providing a multi-objective optimization method in a ubiquitous computing environment, a wearable computer using the same, a computer-readable recording medium storing a program for executing the multi-objective optimization method, which can increase the user's service satisfaction. Specifically, user's requirements of services and limitations based on a variety of condition information are considered as each object and a multi-objective optimization is performed using features of condition information corresponding to a plurality of objects, e.g., quantity of energy and time necessary to acquire the condition information. The user services are provided by assigning weight values to objects that are preferentially considered by the user.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided a wearable computer using a multi-objective optimization in a ubiquitous computing environment, including: a wireless communication unit configured to receive features of condition information and features of service from the outside; a feature collecting unit configured to collect features of condition information according to user's input, and the features of the condition information and the features of the service transmitted from the wireless communication unit; and a computing unit configured to perform the multi-objective optimization by using the features collected through the feature collecting unit in order for optimized user service.

In accordance with another aspect of the present invention, there is provided a multi-objective optimization method in a wearable computer, including the steps of: checking a necessary service; checking a service provider of the necessary service; checking condition information required by the necessary service; checking a condition information source providing the required condition information; acquiring features of the necessary service and features of the required condition information; and performing a multi-objective optimization by using the acquired features.

In accordance with another aspect of the present invention, there is provided a computer-readable recording medium storing a program for executing a multi-objective optimization method in a wearable computer, the multi-objective optimization method including the steps of: checking a necessary service; checking a service provider of the necessary service; checking condition information required by the necessary service; checking a condition information source providing the required condition information; acquiring features of the necessary service and features of the required condition information; and performing a multi-objective optimization by using the acquired features.

### BRIEF DESCRIPTION OF THE DRAWINGS

FIG. 1 illustrates a ubiquitous computing environment in accordance with an embodiment of the present invention.

FIG. 2 illustrates a local service of the ubiquitous computing environment in accordance with an embodiment of the present invention.

FIG. 3 illustrates a remote service of the ubiquitous computing environment in accordance with an embodiment of the present invention.

FIG. 4 illustrates a condition information collection for a multi-objective optimization in a wearable computer in accordance with an embodiment of the present invention.

FIG. 5 is a block diagram of a wearable computer in accordance with an embodiment of the present invention.

FIG. 6 is a flowchart illustrating a multi-objective optimization method for a user service in a wearable computer in accordance with an embodiment of the present invention.

FIG. 7 illustrates a process of providing condition information and service to a wearable computer in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter.

Embodiments of the present invention provide a multi-objective optimization method and a wearable computer using the same. The wearable computer selects a suitable service provider and condition information source in order to provide a requested user service with high user satisfaction. At this point, a multi-objective optimization is performed for optimized choice. However, the present invention is not limited to using the multi-objective optimization for the processes of selecting external service providers and external condition information sources.

In the case of a wearable computer having a limited resource, it is important to manage the energy consumption and a user often requests a correct response rapidly. Therefore, the following description will be made on a case where a multi-objective optimization is performed in such a state that battery status, a total service run time, and accuracy of condition information are considered as a plurality of objects, and weight values are assigned to each object.

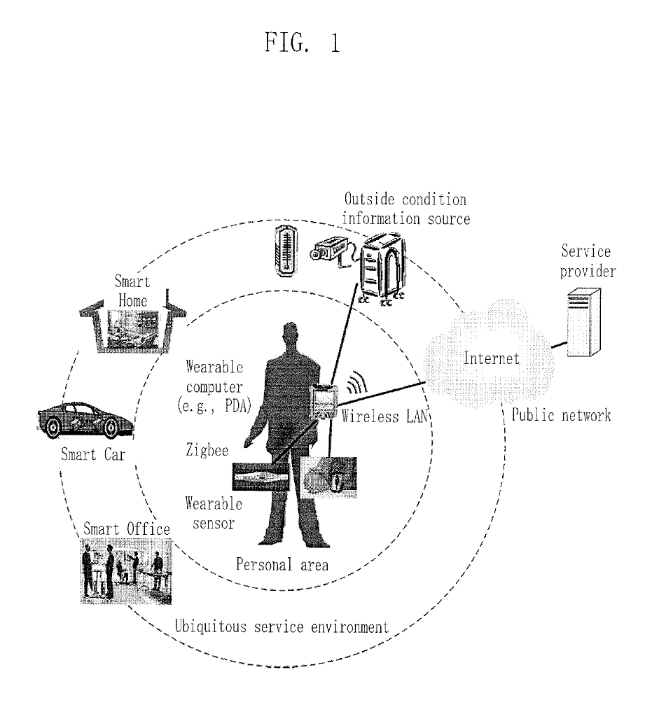

FIG. 1 illustrates a ubiquitous computing environment in accordance with an embodiment of the present invention.

Referring to FIG. 1, the ubiquitous computing environment or ubiquitous service environment in accordance with an embodiment of the present invention includes a wearable system disposed within a personal area, a service provider providing cable/wireless communication with the wearable system, and an outer condition information source disposed out of the wearable system. Specific embodiments of the ubiquitous computing environment include a smart office, a smart car, and a smart home.

The wearable system includes a wearable computer for providing a user service to a user, and a wearable sensor serving as an inter condition information source for collecting biological signals of the user. The wearable computer and one or more wearable sensors receive and transmit a variety of information through a personal area network (PAN), such as Zigbee or Bluetooth.

The wearable computer is connected to an external network through a wireless local area network (LAN) or a wireless communication, e.g., a code division multiple access (CDMA). In this way, the wearable computer is connected to one or more service providers and one or more outer condition information sources. The outer condition information sources include a sensor, a thermometer, and a camera.

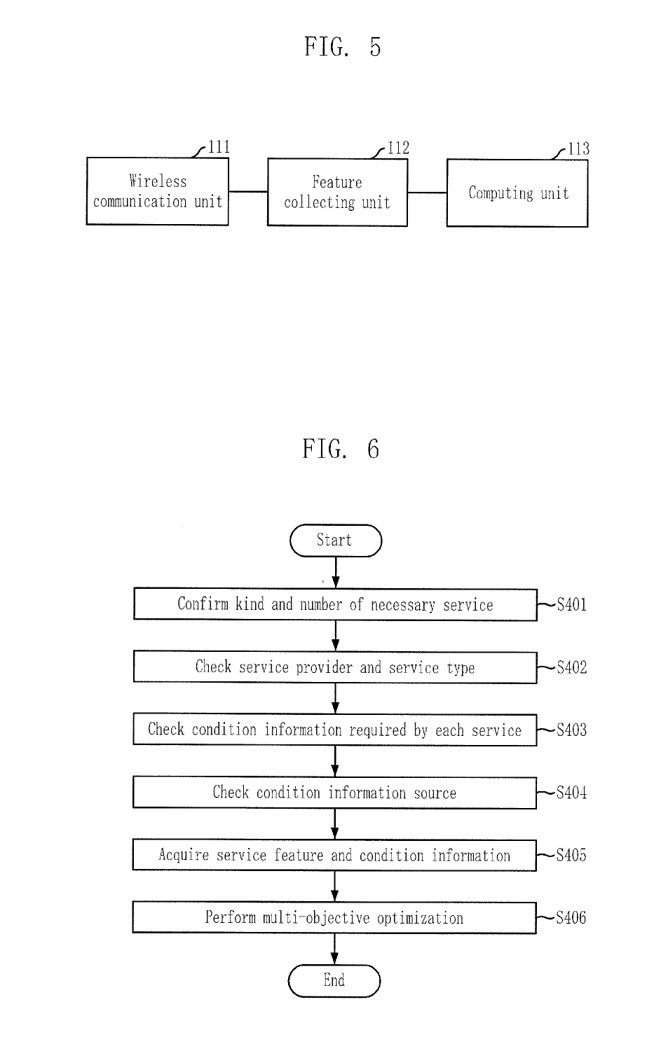

The wearable computer determines an appropriate operation, based on the internal condition information and the external condition information, and then provides a corresponding user service. To this end, internal/external condition information features and service features are collected and a multi-objective optimization is performed using the collected features. Components and operation of the wearable computer will be described later with reference to FIG. 5.

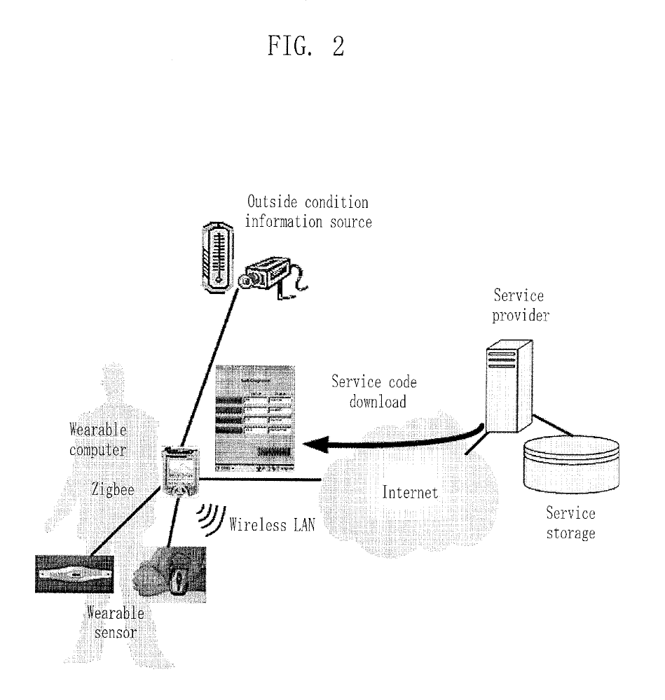

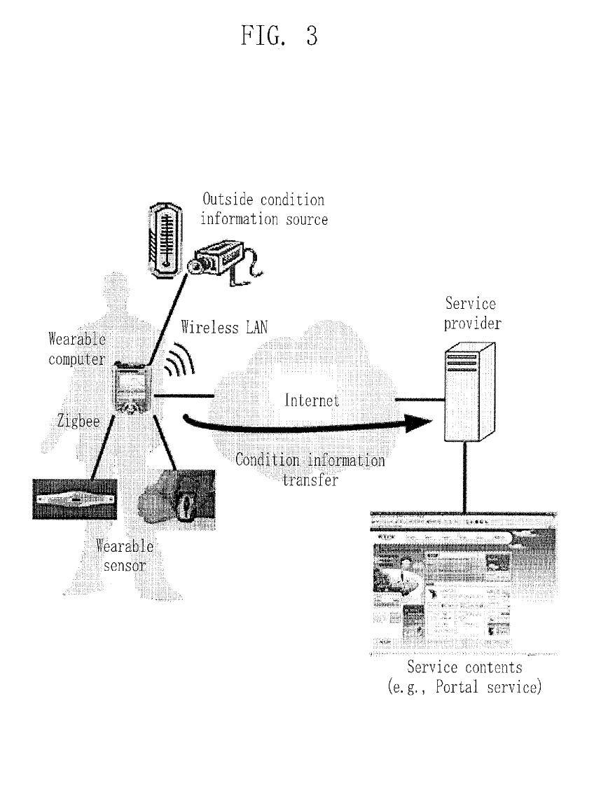

The wearable computer can receive services from the external service provider and provide user services. The services the wearable computer receives from the service provider are classified into a local service and a remote service. The local service and the remote service will be described below with reference to FIGS. 2 and 3.

FIG. 2 illustrates a local service of the ubiquitous computing environment in accordance with an embodiment of the present invention.

Referring to FIG. 2, the local service is performed by downloading a service code from the service provider, e.g., a service server, to the wearable computer, executing the downloaded service code on the wearable computer, and providing the execution result to the user. The wearable computer collects the internal condition information from the wearable sensor and the user input, and collects the external condition information from the external condition information source.

FIG. 3 illustrates a remote service of the ubiquitous computing environment in accordance with an embodiment of the present invention.

Referring to FIG. 3, the remote service executes a service code in the service provider and provides the user service by transmitting the execution result of the service code to the wearable computer. For example, service contents such as portal service stored in a service storage are transmitted to the wearable computer. At this point, the internal/external condition information is finally transmitted to a remote service provider.

In FIGS. 2 and 3, the wearable computer receives service features from the service provider and uses them in the multi-objective optimization.

To provide the user service requested by the user, the wearable computer selects one or more condition information sources and collects internal/external condition information. The wearable computer selects service types, e.g., local service or remote service, and selects a service provider according to the selected service type. That is, the wearable computer determines the service provider from which the user wants to receive the service. When the service type is the remote service, the wearable computer transmits the collected condition information to the service provider. Because the user can simultaneously request a plurality of user services, the wearable computer can simultaneously receive a plurality of services, or can receive them from different service providers.

To perform the entire procedures described above, the wearable computer first receives the features of services and service information, and performs the multi-objective optimization, in order to obtain an optimal solution—that is, determining which condition information collected from the condition information source and which service provided from the service provider will yield the highest energy efficiency.

The process of obtaining the optimal solution in the multi-objective optimization using the service features and the condition information features will be described with reference to the following Equations 1 to 4. Limitations according to the user's requirements and condition information can be considered by assigning a weight value to each object.

The multi-objective optimization for providing the user service under the ubiquitous computing environment in the wearable computer is expressed as the following Equation 1.

$$min {max}_{l} {w}_{l} {Q}_{l} ( {\tilde{S}}_{1} , {\tilde{S}}_{2} , Λ , {\tilde{S}}_{M} , {\tilde{C}}_{11} , {\tilde{C}}_{12} , Λ , {\tilde{C}}_{{IN}_{I}} , Λ , {\tilde{C}}_{{MN}_{M}} ) , \\ l = 1 , Λ , P \qquad Eq . 1$$

where Q₁ is each object, w₁ is a weight value of each object, P is the number of corresponding objects, \tilde{S}ᵢ is a choice variable for Sᵢ, and \tilde{C}ᵢⱼ is a choice variable for the condition information Cᵢⱼ. Sᵢ and Cᵢⱼ will be described later.

The multi-objective optimization can also be achieved using the following Equation 2.

$${min}_{l} {w}_{l} {Q}_{l} ( {\tilde{S}}_{1} , {\tilde{S}}_{2} , Λ , {\tilde{S}}_{M} , {\tilde{C}}_{11} , {\tilde{C}}_{12} , Λ , {\tilde{C}}_{{IN}_{I}} , Λ , {\tilde{C}}_{{MN}_{M}} ) , l = 1 , Λ , P \qquad Eq . 2$$

To further examine Equations 1 and 2, the service to be provided is expressed as S={S₁S₂ΛS_{M}}, where S is a set of the services to be provided, M is the number of the services to be provided, and Sᵢ is an element of the service set S.

The wearable computer must decide whether to provide each service Sᵢ through the local service or the remote service. This is expressed as Choices_{Si}={S_{i,l}S_{i,r}},i=1, Λ,M, where Choices_{Si} is a choice set, S_{i,j} is a local service of Sᵢ, and S_{i,r} is a remote service of Sᵢ. In the multi-objective optimization using Equations 1 and 2, the choice variable \tilde{S}ᵢ must be appropriately selected within the choice set Choices_{Si} with respect to each service.

Each service requires a variety of condition information in order for service execution. Therefore, the set of the condition information for each service is expressed as Cᵢ=(Cᵢ₁Cᵢ₂ΛC_{iN}_{ᵢ}),i=1,Λ,M, where Cᵢ is the set of the condition information necessary for Sᵢ, Cᵢⱼ is an element of Cᵢ and indicates the condition information, and Nᵢ is the number of the condition information necessary for Sᵢ. One of the selectable options with respect to each condition information must be selected. The set of the selectable options is expressed as Choiceᵢⱼ={Cᵢⱼ₁Cᵢⱼ₂ΛC_{ijO}},j=1,Λ,Nᵢ,i=1,Λ,M, where Choices_{Si} is a choice set for the condition information Cᵢⱼ. In the multi-objective optimization using Equations 1 and 2, the choice variable \tilde{C}ᵢⱼ must be appropriately selected within the choice set Choices_{Si} with respect to each service.

In Equation 1, each object Q₁ is a function of the choice variables \tilde{S}ᵢ and \tilde{C}ᵢⱼ and has a value varying according to the selection of the choice variable. Therefore, the present invention provides the multi-objective optimization method that calculates a desired solution by selecting the choice variables \tilde{S}ᵢ and \tilde{C}ᵢⱼ and the wearable computer using the multi-objective optimization method.

In the wearable computer, the object for the user service in the ubiquitous computing environment may be associated with a total energy consumed in the service execution of the wearable computer, a total run time necessary to provide the user service, and accuracy of the condition information. Each object is expressed as the following Equation 3.

Q₁=E_{getC}+E_{process}+Eₙₑₜ

Q₂=T_{getC}+T_{process}+Tₙₑₜ

Q₃=Acc Eq. 3

where E_{getC} is the quantity of energy necessary to acquire all the condition information, T_{getC} is the time necessary to acquire all the condition information, E_{process} is the quantity of energy necessary to process all the services, T_{process} is the time necessary to process all the services, Eₙₑₜ is the quantity of energy necessary to request the service through the network and receive the service code execution result, Tₙₑₜ is the time necessary to request the service through the network and receive the service code execution result, and Acc is the collective accuracy of the condition information.

The smaller value of Acc means the higher accuracy. The above-described parameters are expressed as the following Equation 4.

$$\begin{matrix}{E}_{get C} = {\sum }_{i = 1}^{M} {\sum }_{j}^{{N}_{i}} {\tilde{E}}_{get C}^{ij} , {E}_{process} = {\sum }_{i = 1}^{M} {\tilde{E}}_{process}^{i} , {E}_{net} = {\sum }_{i = 1}^{M} {\tilde{E}}_{net}^{i} \\ {T}_{get C} = {\sum }_{i = 1}^{M} {\sum }_{j}^{{N}_{i}} {\tilde{T}}_{get C}^{ij} , {T}_{process} = {\sum }_{i = 1}^{M} {\tilde{T}}_{process}^{i} , {T}_{net} = {\sum }_{i = 1}^{M} {\tilde{T}}_{net}^{i} , \\ Acc = {\sum }_{i = 1}^{M} {\sum }_{j = 1}^{{N}_{i}} \tilde{A} {cc}^{jj}\end{matrix} \qquad Eq . 4$$

where \tilde{E}_{getC}^{ti} is the quantity of energy necessary to acquire the condition information Cᵢⱼ of the service, \tilde{T}_{getC}^{ij} is the time necessary to acquire the condition information Cᵢⱼ of the service, \tilde{E}_{process}ⁱ is the quantity of energy necessary to execute the service Sᵢ, \tilde{T}_{process}ⁱ is the time necessary to execute the service Sᵢ, \tilde{E}ₙₑₜ^{t} is the quantity of energy necessary to request the service Sᵢ through the network and receive its result, \tilde{T}ₙₑₜ^{t} is the time necessary to request the service Sᵢ through the network and receive its result, and Ãcc^{ij} is the accuracy of the condition information Cᵢⱼ.

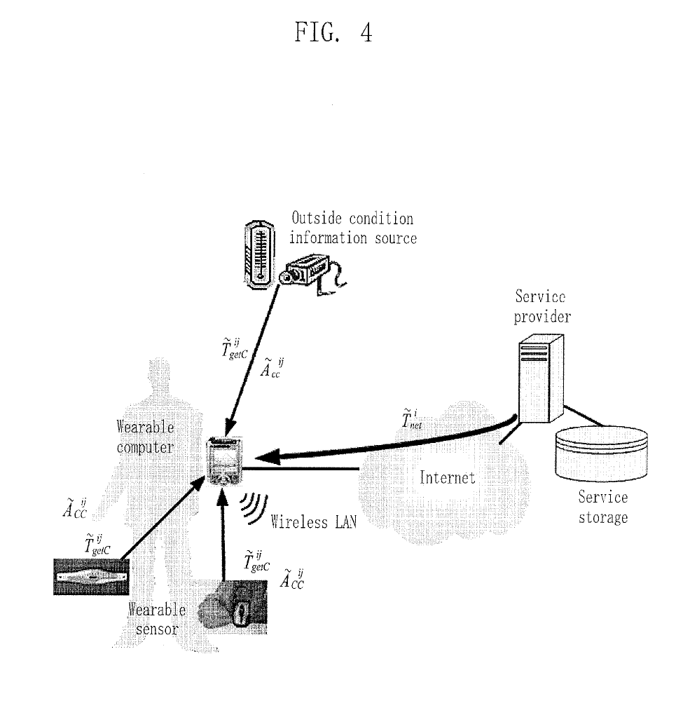

FIG. 4 illustrates the condition information collection for the multi-objective optimization in the wearable computer in accordance with an embodiment of the present invention.

Referring to FIG. 4, the wearable computer receives the features of service and condition information of each object from the service provider and one or more internal/external condition information sources in order for the multi-objective optimization. For example, the wearable computer receives the quantity of energy and the time necessary to acquire the condition information in order to provide the user service requested by the user.

FIG. 5 is a block diagram of a wearable computer in accordance with an embodiment of the present invention.

Referring to FIG. 5, the wearable computer includes a wireless communication unit 111, a feature collecting unit 112, and a computing unit 113. The wireless communication unit 111 communicates with a wearable sensor in a wireless manner and is connected to an external network. The feature collecting unit 112 collects features of internal condition information according to information of the wearable sensor and user's input, features of external condition information of an external condition information source, and features of services received through the wireless communication unit 111. The computing unit 113 performs the multi-objective optimization, based on one or more features received from the feature collecting unit 112. The wearable computer may further include an input unit, an output unit, and a memory.

The wireless communication unit 111 receives the features of the internal condition information, such as biological signals of the user, in a wireless manner through communication with one or more wearable sensors, and transmits the received features to the feature collecting unit 112. Further, the wireless communication unit 111 communicates with an external service provider and an external condition information source through wireless access to the external network, receives the features of the external condition information and the features of services, and the transmits the received features to the feature collecting unit 112.

The feature collecting unit 112 collects the features of the internal condition information through the wireless communication unit 111 and the user's input, the features of the external condition information transmitted from the external information source, and the features of the services received from the service provider.

The computing unit 113 performs the multi-objective optimization based on Equations 1 and 2 by using the features of the condition information and the features of the services transmitted from the feature collecting unit 112. Prior to the multi-objective optimization, the computing unit 113 configures the multiple objects by using Equations 3 and 4.

FIG. 6 is a flowchart illustrating the multi-objective optimization method for the user service in the wearable computer in accordance with an embodiment of the present invention.

Referring to FIG. 6, the wearable computer checks type and number of necessary services in step S401. For example, the wearable computer checks one or more user services requested by the user through an input device.

In step S402, the wearable computer checks a service provider, which can provide the necessary service, and its service type, e.g., a local service or a remote service. A plurality of service providers may be checked.

In steps S403 and S404, the wearable computer checks condition information required by the necessary service, and checks a condition information source that can provide the condition information.

In step S405, the wearable computer acquires the features of the necessary service and the features of the necessary condition information, e.g., quantity of energy and time necessary to acquire the condition information, and accuracy of the condition information.

In step S406, the wearable computer performs the multi-objective optimization by using the acquired features of the service and condition information.

Based on the result of the multi-objective optimization, the wearable computer collects the condition information from the internal/external information sources, receives the service code or the service code execution result from the determined service provider, and provides the user service. At this point, the wearable computer or the service provider finally receives the condition information according to the service type.

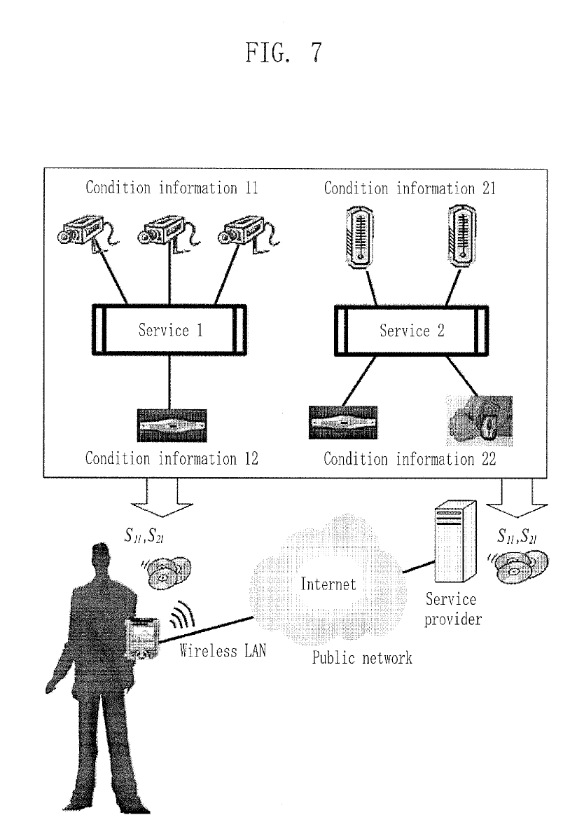

FIG. 7 illustrates the process of providing condition information and service to the wearable computer in accordance with an embodiment of the present invention.

Referring to FIG. 7, the wearable computer provides two types of services: service 1 and service 2. The service 1 uses two pieces of condition information. The first condition information has three options and the second condition information has one option. The service 2 uses two pieces of condition information, and each of the condition information has two options. The following Tables 1 to 5 show quantity of energy, run time, and accuracy of condition information, which are necessary to receive the service from the service provider and receive one or more condition information from the internal/external condition information source.

The following Table 1 shows the quantity of energy and the run time, which are necessary to acquire the condition information in the case of the service 1.

TABLE 1

| | |
|---|---|
| Condition | Condition |
| Information 1 | Information 2 |
| (i = 1, j = 1) | (i = 1, j = 2) |

Choices

| | Choice 1 | Choice 2 | Choice 3 | Choice 1 |
|---|---|---|---|---|
| \tilde{E}_{getC}^{ij} | 0.3 | 0.15 | 0.1 | 0.3 |
| \tilde{T}_{getC}^{ij} | 0.1 | 0.2 | 0.3 | 0.1 |

The following Table 2 shows the quantity of energy and the run time, which are necessary to acquire the condition information in the case of the service 2.

TABLE 2

| | |
|---|---|
| Condition | Condition |
| Information 1 | Information 2 |
| (i = 2, j = 1) | (i = 2, j = 2) |

Choices

| | Choice 1 | Choice 2 | Choice 1 | Choice 2 |
|---|---|---|---|---|
| \tilde{E}_{getC}^{ij} | 0.3 | 0.1 | 0.1 | 0.05 |
| \tilde{T}_{getC}^{ij} | 0.1 | 0.3 | 0.3 | 0.4 |

The following Table 3 shows the quantity of energy and the run time, which are necessary to perform the services when the services are combined, and the quantity of energy and the run time when the services are executed through the network.

TABLE 3

| Service 1 | Local | Local | Remote | Remote |
|---|---|---|---|---|
| Service 2 | Local | Remote | Local | Remote |
| Combinationof services | $\{ \begin{matrix}{S}_{1 , l} , \\ {S}_{2 , l}\end{matrix} \}$ | $\{ \begin{matrix}{S}_{1 , l} , \\ {S}_{2 , r}\end{matrix} \}$ | $\{ \begin{matrix}{S}_{1 , r} , \\ {S}_{2 , l}\end{matrix} \}$ | $\{ \begin{matrix}{S}_{1 , r} , \\ {S}_{2 , r}\end{matrix} \}$ |
| \tilde{E}_{process}ⁱ | 0.7 | 0.3 | 0.4 | 0 |
| \tilde{T}_{process}ⁱ | 0.5 | 0.2 | 0.3 | 0 |
| \tilde{E}ₙₑₜⁱ | 0 | 0.1 | 0.2 | 0.3 |
| \tilde{T}ₙₑₜⁱ | 0 | 0.1 | 0.2 | 0.3 |

The following Table 4 shows the accuracy of the condition information in the case of the service 1.

TABLE 4

| | |
|---|---|
| Condition | Condition |
| Information 1 | Information 2 |
| (i = 1, j = 1) | (i = 1, j = 2) |

Choices

| | Choice 1 | Choice 2 | Choice 3 | Choice 1 |
|---|---|---|---|---|
| Ãcc^{ij} | 1 | 0.5 | 0.4 | 0.9 |

The following Table 5 shows the accuracy of the condition information in the case of the service 2.

TABLE 2

| | |
|---|---|
| Condition | Condition |
| Information 1 | Information 2 |
| (i = 2, j = 1) | (i = 2, j = 2) |

Choices

| | Choice 1 | Choice 2 | Choice 1 | Choice 2 |
|---|---|---|---|---|
| Ãcc^{ij} | 1.0 | 0.5 | 0.9 | 0.3 |

The following Table 6 shows the result of the multi-objective optimization when using weight values of w₁=0.1, w₂=0.1, w₃=0.9 and weight values of w₁=0.9, w₂=0.9, W₃=0.1.

TABLE 6

| | | |
|---|---|---|
| w₁ | 0.1 | 0.9 |
| w₂ | 0.1 | 0.9 |
| w₃ | 0.9 | 0.1 |
| \tilde{C}₁₁ | Choice 1 | Choice 2 |
| \tilde{C}₂₁ | Choice 1 | Choice 1 |
| \tilde{C}₂₂ | Choice 1 | Choice 2 |
| \tilde{S}₁ | Local | Remote |
| \tilde{S}₂ | Local | Remote |
| Q₁ | 1.7 | 1.1 |
| Q₂ | 1.1 | 1.1 |
| Q₃ | 0.5 | 0.6 |

It can be seen from Table 6 that the object having a larger weight value has a higher priority. In this way, more desirable Pareto optimal solution can be obtained.

In accordance with the embodiments of the present invention, the wearable computer chooses the condition information source by using the multi-objective optimization in the ubiquitous computing environment and selects the service provider and the service providing method, thereby improving the user's service satisfaction.

User's requirements and limitations based on the condition information from the internal/external condition information sources are considered as the respective objects. Weight values are assigned to the respective objects, and the optimal solution for the objects is obtained. Then, the service is provided to the user according to the obtained optimal solution, thereby improving the user's satisfaction.

The methods in accordance with the embodiments of the present invention can be realized as programs and stored in a computer-readable recording medium that can execute the programs. Examples of the computer-readable recording medium include CD-ROM, RAM, ROM, floppy disks, hard disks, magneto-optical disks and the like.

While the present invention has been described with respect to the specific embodiments, it will be apparent to those skilled in the art that various changes and modifications may be made without departing from the spirit and scope of the invention as defined in the following claims.

What is claimed is:

1. A wearable computer using a multi-objective optimization in a ubiquitous computing environment, comprising:
a wireless communication unit configured to receive features of condition information and features of service from the outside;
a feature collecting unit configured to collect features of condition information according to user's input, and the features of the condition information and the features of the service transmitted from the wireless communication unit; and
a computing unit configured to perform the multi-objective optimization by using the features collected through the feature collecting unit in order for optimized user service.

2. The wearable computer of claim 1, wherein the wireless communication unit receives features of internal condition information from one or more internal condition information sources, features of external condition information from one or more external condition information sources, and features of services from one or more service providers;
the feature collecting unit collects the features of the internal condition information according to the user's input, the features of the internal condition information from the internal condition information source, the features of the external condition information, and the features of the services; and
the computing unit performs the multi-objective optimization by using the service features of the service provider and the features of the internal/external condition information, which are necessary for providing one or more user services according to user's request.

3. The wearable computer of claim 2, wherein the feature collecting unit collects service run time, quantity of energy and time necessary to acquire the internal/external condition information, and accuracy of the internal/external condition information.

4. The wearable computer of claim 3, wherein the computing unit configures multiple objects, based on an equation, which is expressed as:
Q₁=E_{getC}+E_{process}+Eₙₑₜ
Q₂=T_{getC}+T_{process}+Tₙₑₜ
Q₃=Acc
where E_{getC} is the quantity of energy necessary to acquire the condition information, T_{getC} is the time necessary to acquire the condition information, E_{process} is the quantity of energy necessary to process the services, T_{process} is the time necessary to process the services, Eₙₑₜ is the quantity of energy necessary to request the service through the network and receive the service code execution result, Tₙₑₜ is the time necessary to request the service through the network and receive the service code execution result, and Acc is the accuracy of the condition information.

5. The wearable computer of claim 3, wherein the computing unit configures multiple objects, based on an equation, which is expressed as:
$$\begin{matrix}{E}_{get C} = {\sum }_{i = 1}^{M} {\sum }_{j}^{{N}_{i}} {\tilde{E}}_{get C}^{ij} , {E}_{process} = {\sum }_{i = 1}^{M} {\tilde{E}}_{process}^{i} , {E}_{net} = {\sum }_{i = 1}^{M} {\tilde{E}}_{net}^{i} \\ {T}_{get C} = {\sum }_{i = 1}^{M} {\sum }_{j}^{{N}_{i}} {\tilde{T}}_{get C}^{ij} , {T}_{process} = {\sum }_{i = 1}^{M} {\tilde{T}}_{process}^{i} , {T}_{net} = {\sum }_{i = 1}^{M} {\tilde{T}}_{net}^{i} , \\ Acc = {\sum }_{i = 1}^{M} {\sum }_{j = 1}^{{N}_{i}} \tilde{A} {cc}^{jj}\end{matrix}$$
where \tilde{E}_{getC}^{ij} is the quantity of energy necessary to acquire the condition information Cᵢⱼ of the service, \tilde{T}_{getC}^{ij} is the time necessary to acquire the condition information Cᵢⱼ of the service, \tilde{E}_{process}ⁱ is the quantity of energy necessary to execute the service Sᵢ, \tilde{T}_{process}ⁱ is the time necessary to execute the service Sᵢ, \tilde{E}ₙₑₜ^{t} is the quantity of energy necessary to request the service Sᵢ through the network and receive its result, \tilde{T}ₙₑₜ^{t} is the time necessary to request the service Sᵢ through the network and receive its result, and Ãcc^{ij} is the accuracy of the condition information Cᵢⱼ.

6. The wearable computer of claim 2, wherein the internal condition information source includes a wearable sensor.

7. The wearable computer of claim 1, wherein the computing unit performs the multi-objective optimization, based on an equation, which is expressed as:
$$min {max}_{l} {w}_{l} {Q}_{l} ( {\tilde{S}}_{1} , {\tilde{S}}_{2} , Λ , {\tilde{S}}_{M} , {\tilde{C}}_{11} , {\tilde{C}}_{12} , Λ , {\tilde{C}}_{{IN}_{I}} , Λ , {\tilde{C}}_{{MN}_{M}} ) , l = 1 , Λ , P$$
where Q₁ is each of the objects, w₁ is a weight value for each of the objects, P is the number of corresponding objects, \tilde{S}ᵢ is a choice variable for Sᵢ, and \tilde{C}ᵢⱼ is a choice variable for the condition information Cᵢⱼ.

8. The wearable computer of claim 1, wherein the computing unit performs the multi-objective optimization, based on an equation, which is expressed as:
$${min}_{l} {w}_{l} {Q}_{l} ( {\tilde{S}}_{1} , {\tilde{S}}_{2} , Λ , {\tilde{S}}_{M} , {\tilde{C}}_{11} , {\tilde{C}}_{12} , Λ , {\tilde{C}}_{{IN}_{I}} , Λ , {\tilde{C}}_{{MN}_{M}} ) , l = 1 , Λ , P$$
where Q₁ is each of the objects, w₁ is a weight value for each of the objects, P is the number of corresponding objects, \tilde{S}ᵢ is a choice variable for Sᵢ, and \tilde{C}ᵢⱼ is a choice variable for the condition information Cᵢⱼ.

9. A multi-objective optimization method in a wearable computer, comprising the steps of:
checking a necessary service;
checking a service provider of the necessary service;
checking condition information required by the necessary service;
checking a condition information source providing the required condition information;
acquiring features of the necessary service and features of the required condition information; and
performing a multi-objective optimization by using the acquired features.

10. The multi-objective optimization method of claim 9, wherein the step of checking the service provider includes the steps of:
checking one or more service providers, and the step of checking condition information includes the step of: and
checking internal/external condition information required by the necessary service.

11. The multi-objective optimization method of claim 10, wherein the step of acquiring features includes the step of:
collecting service run time, quantity of energy and time necessary to acquire the internal/external condition information, and accuracy of the internal/external condition information.

12. The multi-objective optimization method of claim 11, wherein the step of performing the multi-objective optimization performs the optimization on multiple objects configured based on an equation, which is expressed as:
Q₁=E_{getC}+E_{process}+Eₙₑₜ
Q₂=T_{getC}+T_{process}+Tₙₑₜ
Q₃=Acc
where E_{getC} is the quantity of energy necessary to acquire the condition information, T_{getC} is the time necessary to acquire the condition information, E_{process} is the quantity of energy necessary to process the services, T_{process} is the time necessary to process the services, Eₙₑₜ is the quantity of energy necessary to request the service through the network and receive the service code execution result, Tₙₑₜ is the time necessary to request the service through the network and receive the service code execution result, and Acc is the accuracy of the condition information.

13. The multi-objective optimization method of claim 11, wherein the step of performing a multi-objective optimization performs the optimization on multiple objects configured based on an equation, which is expressed as:
$$\begin{matrix}{E}_{get C} = {\sum }_{i = 1}^{M} {\sum }_{j}^{{N}_{i}} {\tilde{E}}_{get C}^{ij} , {E}_{process} = {\sum }_{i = 1}^{M} {\tilde{E}}_{process}^{i} , {E}_{net} = {\sum }_{i = 1}^{M} {\tilde{E}}_{net}^{i} \\ {T}_{get C} = {\sum }_{i = 1}^{M} {\sum }_{j}^{{N}_{i}} {\tilde{T}}_{get C}^{ij} , {T}_{process} = {\sum }_{i = 1}^{M} {\tilde{T}}_{process}^{i} , {T}_{net} = {\sum }_{i = 1}^{M} {\tilde{T}}_{net}^{i} , \\ Acc = {\sum }_{i = 1}^{M} {\sum }_{j = 1}^{{N}_{i}} \tilde{A} {cc}^{jj}\end{matrix}$$
where \tilde{E}_{getC}^{ij} is the quantity of energy necessary to acquire the condition information Cᵢⱼ of the service, \tilde{T}_{getC}^{ij} is the time necessary to acquire the condition information Cᵢⱼ of the service, \tilde{E}_{process}ⁱ is the quantity of energy necessary to execute the service Sᵢ, \tilde{T}_{process}ⁱ is the time necessary to execute the service Sᵢ, \tilde{E}ₙₑₜ^{t} is the quantity of energy necessary to request the service Sᵢ through the network and receive its result, \tilde{T}ₙₑₜ^{t}, is the time necessary to request the service Sᵢ through the network and receive its result, and Ãcc^{ij} is the accuracy of the condition information Cᵢⱼ.

14. The multi-objective optimization method of claim 9, wherein the step of performing a multi-objective optimization performs the multi-objective optimization, based on an equation, which is expressed as:
$$min {max}_{l} {w}_{l} {Q}_{l} ( {\tilde{S}}_{1} , {\tilde{S}}_{2} , Λ , {\tilde{S}}_{M} , {\tilde{C}}_{11} , {\tilde{C}}_{12} , Λ , {\tilde{C}}_{{IN}_{I}} , Λ , {\tilde{C}}_{{MN}_{M}} ) , l = 1 , Λ , P$$
where Q₁ is each of the objects, w₁ is a weight value for each of the objects, P is the number of corresponding objects, \tilde{S}ᵢ is a choice variable for Sᵢ, and \tilde{C}ᵢⱼ is a choice variable for the condition information Cᵢⱼ.

15. The multi-objective optimization method of claim 9, wherein the step of performing a multi-objective optimization performs the multi-objective optimization, based on an equation, which is expressed as:
$${min}_{l} {w}_{l} {Q}_{l} ( {\tilde{S}}_{1} , {\tilde{S}}_{2} , Λ , {\tilde{S}}_{M} , {\tilde{C}}_{11} , {\tilde{C}}_{12} , Λ , {\tilde{C}}_{{IN}_{I}} , Λ , {\tilde{C}}_{{MN}_{M}} ) , l = 1 , Λ , P$$
where Q₁ is each of the objects, w₁ is a weight value for each of the objects, P is the number of corresponding objects, \tilde{S}ᵢ is a choice variable for Sᵢ, and \tilde{C}ᵢⱼ is a choice variable for the condition information Cᵢⱼ.

16. A computer-readable recording medium storing a program for executing a multi-objective optimization method in a wearable computer, the multi-objective optimization method comprising the steps of:
checking a necessary service;
checking a service provider of the necessary service;
checking condition information required by the necessary service;
checking a condition information source providing the required condition information;
acquiring features of the necessary service and features of the required condition information; and
performing a multi-objective optimization by using the acquired features.
